(19) United States
(12) Patent Application Publication
(10) Pub. No.: US 2016/0041412 A1
(43) Pub. Date: Feb. 11, 2016

(54) LIQUID CRYSTAL PANEL TEST CIRCUIT

(71) Applicant: Shenzhen China Star Optoelectronics Technology Co., Shenzhen, Guangdong (CN)

(72) Inventor: Qibiao LV, Shenzhen, Guangdong (CN)

(73) Assignee: Shenzhen China Star Optoelectronics Technology Co. Ltd., Shenzhen, Guangdong (CN)

(21) Appl. No.: 14/390,764

(22) PCT Filed: Aug. 21, 2014
(86) PCT No.: PCT/CN2014/084873

§ 371 Date: Oct. 3, 2014

(30) Foreign Application Priority Data
Aug. 8, 2014 (CN) 201410391240.9

(51) Int. Cl. G02F 1/13; G02F 1/1362; G02F 1/1368

(52) U.S. Cl. CPC G02F 1/1309; G02F 1/1368; G02F 1/136286; G02F 2001/136254

(57) ABSTRACT

The present invention provides a liquid crystal panel test circuit, comprising a plurality of gate welding portions (3) and source welding portions (4), a plurality of gate line testing short bars (5) and data line testing short bars (6), and at least one first TFT switch (7) is located on a path connecting each of the gate welding portions (3) to the gate line testing short bar (5), and at least one second TFT switch (8) is located on a path connecting each of the source welding portions (4) to the data line testing short bar (6), and a gate of the first TFT switch (7) is coupled to a first control signal line (9), and a gate of the second TFT switch (8) is coupled to a second control signal line (10); the connections or disconnections between the gate line testing short bars (5) and the gate lines (1), the connections or disconnections between data line testing short bars (6) and the data lines (2) are respectively controlled by switching signals transmitted from the first, second control signal lines (9, 10).

### FIELD OF THE INVENTION

The present invention relates to a display skill field, and more particularly to a liquid crystal panel test circuit.

### BACKGROUND OF THE INVENTION

A Liquid Crystal Display (LCD) is a major display device nowadays and possesses advantages of being ultra thin, power saved and radiation free. It has been widely utilized in, such as LCD TVs, mobile phones, PDAs (personal digital assistance), digital cameras, laptop screens or notebook screens.

The most liquid crystal displays on the market are backlight type liquid crystal displays, which comprises a shell, a liquid crystal panel located in the shell and a backlight module located in the shell.

The common structure of the present liquid crystal panel can comprise a Color Filter (CF) substrate, a Thin Film Transistor Array Substrate (TFT Array Substrate), and a Liquid Crystal Layer located between the two substrates. The working principle is that the light of backlight module is reflected to generate images by applying driving voltages to the two glass substrate for controlling the rotations of the liquid crystal molecules.

At the end of the liquid crystal panel manufacture process, it is required to implement test to the internal circuit of the panel for discovering problems and repairing them in time. Such procedure is so called Cell Test. A common cell test widely utilized in prior arts is shown in FIG. 1. Multiple gate lines 100 and data lines 200 which are orthogonal with one another are located in the panel display area. Each of the gate lines 100 is electrically connected to a gate bonding pad 300 on the periphery of the liquid crystal panel display area, and each of the data lines 200 is electrically connected to a source bonding pad 400 on the periphery of the liquid crystal panel display area. The gate bonding pad 300 and the source bonding pad 400 are respectively connected to a gate line test shorting bar 500 and a data line test shorting bar 600 via metal pins 310, 410. When the panel test is executed, test signals are respectively transmitted to the gate line test shorting bar 500 and data line test shorting bar 600 for testing the internal circuit of the panel. After the panel test is finished, it is necessary to cut off the metal pins 310, 410 by Laser Cut. The isolation layer (SiNx) covering the metal pins 310, 410 will be removed at the same time. Trenches will be left on the Laser Cut positions 700 and the ends of the remaining parts of the metal pins 310, 410 can be easily corroded and the corrosion will spread along to the gate bonding pad 300, the source bonding pad 400 and the gate lines 100, the data lines 200 respectively connected to the both, which may cause the transmission interruption to the panel working signals and the abnormal panel display.

### SUMMARY OF THE INVENTION

An objective of the present invention is to provide a liquid crystal panel test circuit that the laser cutting for the metal pins of the gate welding portions and the source welding portions is not required after testing the panel to prevent the issues bad panel display due to the corrosion occurred to the ends of the metal pins. The production efficiency is raised and the manufacture cost is reduced while the panel quality is promoted.

For realizing the aforesaid objective, the present invention provides a liquid crystal panel test circuit, comprising a plurality of gate welding portions and source welding portions located on the periphery of a liquid crystal panel display area, a plurality of gate line testing short bars and data line testing short bars located on the periphery of the liquid crystal panel display area, and the gate welding portions are correspondingly and electrically connected to the gate line testing short bars, and the source welding portions are correspondingly and electrically connected to the data line testing short bars, and at least one first TFT switch is located on a path connecting each of the gate welding portions to the gate line testing short bar, and at least one second TFT switch is located on a path connecting each of the source welding portions to the data line testing short bar, and a gate of the first TFT switch is coupled to a first control signal line, and a gate of the second TFT switch is coupled to a second control signal line; the connections or disconnections between the gate line testing short bars and the gate lines, the connections or disconnections between data line testing short bars and the data lines are respectively controlled by switching signals transmitted from the first, second control signal lines.

Each of the gate welding portions is electrically coupled to a gate line in the liquid crystal panel display area, and each of the source welding portions is electrically coupled to a data line in the liquid crystal panel display area.

The gate line testing short bar is coupled to a gate line test signal, and the data line testing short bar is coupled to a data line test signal; as the first, second control signal lines transmit switch on signals, both of the first, second TFT switches are conducted, and the gate line testing short bar and the gate line are connected, and the data line testing short bar and the data line are connected, and the gate line test signal and the data line test signal are respectively transmitted to the gate line and the data line; as the first, second control signal lines transmit switch off signals, both of the first, second TFT switches are not conducted, and the gate line testing short bar and the gate line are disconnected, and the data line testing short bar and the data line are disconnected.

The switching off signal is a gate low voltage of the first TFT switch or the second TFT switch or is directly grounded.

One first TFT switch is located on the path connecting each of the gate welding portions to the gate line testing short bar, and one second TFT switch is located on the path connecting each of the source welding portions to the data line testing short bar.

A source of the first TFT switch is coupled to the gate line testing short bar and a drain thereof is coupled to the corresponding gate line with the gate welding portion; a source of the second TFT switch is coupled to the data line testing short bar, and a drain thereof is coupled to the corresponding data line with the source welding portion.

Two first TFT switches are located on the path connecting each of the gate welding portions to the gate line testing short bar, and two second TFT switches are located on the path connecting each of the source welding portions to the data line testing short bar.

In the two first TFT switches on each path, a source of one first TFT switch is coupled to the gate line testing short bar, and a drain of the first TFT switch is coupled to a source of the other first TFT switch, and a drain of the other first TFT switch is coupled to the corresponding gate line with the gate welding portion; in the two second TFT switches on each path, a source of one second TFT switch is coupled to the data line testing short bar, and a drain of the second TFT switch is coupled to a source of the other second TFT switch, and a drain of the other second TFT switch is coupled to the corresponding data line with the source welding portion.

The benefits of the present invention are: according to the liquid crystal panel test circuit of the present invention, at least one first TFT switch is located on the path connecting each of the gate welding portions to the gate line testing short bar, and at least one second TFT switch is located on the path connecting each of the source welding portions to the data line testing short bar, and whether the first, second TFT switches are conducted or not can be respectively controlled by switching signals transmitted from the first, second control signal lines. Accordingly, the connections or disconnections between the gate line testing short bars and the gate lines, the connections or disconnections between data line testing short bars and the data lines can be controlled so that the laser cutting for the metal pins of the gate welding portions and the source welding portions is not required after testing the panel to prevent the issues bad panel display due to the corrosion occurred to the ends of the metal pins. The production efficiency is raised and the manufacture cost is reduced while the panel quality is promoted.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution, as well as beneficial advantages, of the present invention will be apparent from the following detailed description of an embodiment of the present invention, with reference to the attached drawings.

In drawings,

FIG. 1 is a structural diagram of a liquid crystal panel test circuit according to prior art;

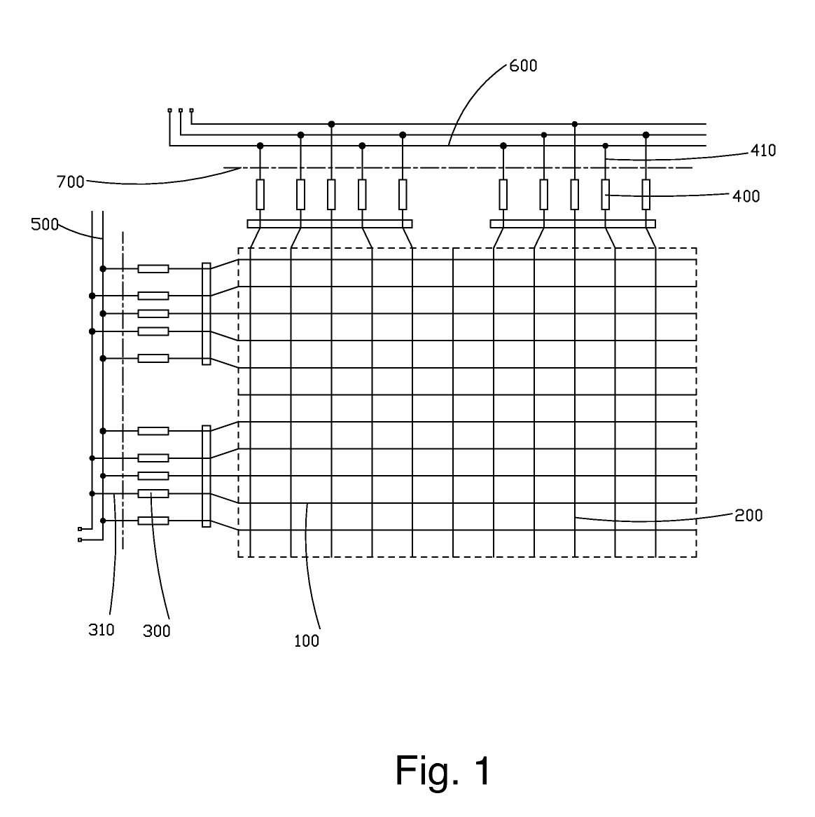

FIG. 2 is a structural diagram showing of a first embodiment of a liquid crystal panel test circuit according to the present invention;

FIG. 3 is a structural diagram showing of a second embodiment of a liquid crystal panel test circuit according to the present invention.

### DETAILED DESCRIPTION OF PREFERRED EMBODIMENTS

Embodiments of the present invention are described in detail with the technical matters, structural features, achieved objects, and effects with reference to the accompanying drawings as follows.

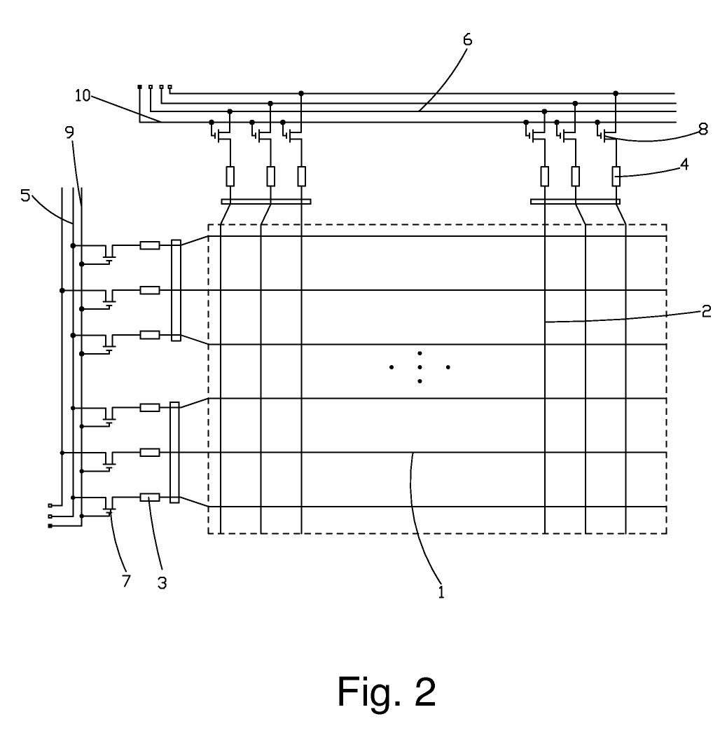

Please refer from FIG. 2 which is a structural diagram showing of a first embodiment of a liquid crystal panel test circuit according to the present invention. The liquid crystal panel test circuit comprises a plurality of gate welding portions 3 and source welding portions 4 located on the periphery of a liquid crystal panel display area, a plurality of gate line testing short bars 5 and data line testing short bars 6 located on the periphery of the liquid crystal panel display area, at least one first TFT switch 7 is located on a path connecting each of the gate welding portions 3 to the gate line testing short bar 5, at least one second TFT switch 8 is located on a path connecting each of the source welding portions 4 to the data line testing short bar 6, a first control signal line 9, employed to control whether the first TFT switch 7 is conducted or not and a second control signal line 10, employed to control whether the second TFT switch 8 is conducted or not.

Each of the gate welding portions 3 is electrically coupled to a gate line 1 in the liquid crystal panel display area, and each of the source welding portions 4 is electrically coupled to a data line 2 in the liquid crystal panel display area.

The gate line testing short bar 5 is coupled to a gate line test signal and transmits the gate line test signal; the data line testing short bar 6 is coupled to a data line test signal and transmits the data line test signal. The first control signal line 9 is coupled to switching signals employed to control the first TFT switch 7 and transmits the switching signals; the second control signal line 10 is coupled to switching signals employed to control the second TFT switch 8 and transmits the switching signals.

In the first embodiment, one first TFT switch 7 is located on the path connecting each of the gate welding portions 3 to the gate line testing short bar 5, and a gate of the first TFT switch 7 is coupled to a first control signal line 9, and a source thereof is coupled to the gate line testing short bar 5 and a drain thereof is coupled to the corresponding gate line 1 with the gate welding portion 3; one second TFT switch 8 is located on the path connecting each of the source welding portions 4 to the data line testing short bar 6, and a gate of the second TFT switch 8 is coupled to a second control signal line 10, and a source thereof is coupled to the data line testing short bar 6, and a drain thereof is coupled to the corresponding data line 2 with the source welding portion 4. It can readily be understood that the source and the drain of the first TFT switch 7 can be exchanged, and the source and the drain of the second TFT switch 8 also can be exchanged.

In test procedure of the liquid crystal panel, as the first, second control signal lines 9, 10 transmit switch on signals, the source and the drain of the first TFT switch 7 are conducted and the source and the drain of the second TFT switch 8 are conducted. Accordingly, the gate line testing short bar 5 and the gate line 1 are connected, and the data line testing short bar 6 and the data line 2 are connected, and the gate line test signal and the data line test signal are respectively transmitted to the gate line 1 and the data line 2 to implement test to the internal circuit of the liquid crystal panel; as the first, second control signal lines 9, 10 transmit switch off signals, the source and the drain of the first TFT switch 7 are not conducted and the source and the drain of the second TFT switch 8 are not conducted. Accordingly, the gate line testing short bar 5 and the gate line 1 are disconnected, and the data line testing short bar 6 and the data line 2 are disconnected.

Significantly, as the test procedure of the liquid crystal panel is accomplished, for guaranteeing that the first TFT switch 7 and the second TFT switch 8 are in complete disconnected state and preventing the mutual interferences of the normal working signals, the switching off signals transmitted by the first, second control signal lines 9, 10 can be lower voltages, and the gate low voltages can be gate low voltages for the first TFT switch 7 and the second TFT switch 8 or directly grounded.

Compared with the metal pins employed in the liquid crystal panel test circuit according to prior arts, the liquid crystal panel test circuit here is capable of dismissing the laser cutting for the metal pins of the gate welding portions and the source welding portions after testing the panel to prevent the issues bad panel display due to the corrosion occurred to the ends of the metal pins. The production efficiency is raised and the manufacture cost is reduced while the panel quality is promoted.

Principally, the first embodiment has already satisfying the requirements of the liquid crystal panel test. However, both the amount of the first TFT switch 7 located on the path connecting each of the gate welding portions 3 to the gate line testing short bar 5 and the second TFT switch 8 located on the path connecting each of the source welding portions 4 to the data line testing short bar 6 are only one, the risks of leakage failure and the mutual interferences of the normal working signals in normal display of the liquid crystal panel for single TFT switch exist.

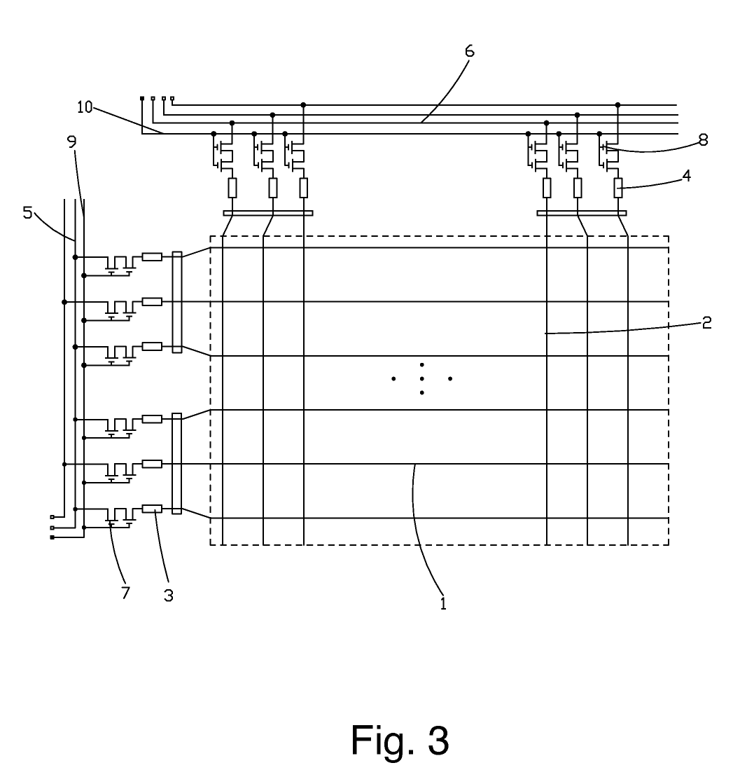

Please refer to FIG. 3, which is a structural diagram showing of a second embodiment of a liquid crystal panel test circuit according to the present invention. The second embodiment is to optimize the first embodiment. Two first TFT switches 7 are located on the path connecting each of the gate welding portions 3 to the gate line testing short bar 5, and two second TFT switches 8 are located on the path connecting each of the source welding portions 4 to the data line testing short bar 6.

Specifically, In the two first TFT switches 7 on each path, both gates of one first TFT switches 7 are coupled to the first control signal line 9, and a source of one first TFT switch 7 is coupled to the gate line testing short bar 5, and a drain of the first TFT switch 7 is coupled to a source of the other first TFT switch 7, and a drain of the other first TFT switch 7 is coupled to the corresponding gate line 1 with the gate welding portion 3; in the two second TFT switches 8 on each path, both gates of the two second TFT switches 8 are coupled to the second control signal line 10, and a source of one second TFT switch 8 is coupled to the data line testing short bar 6, and a drain of the second TFT switch 8 is coupled to a source of the other second TFT switch 8, and a drain of the other second TFT switch 8 is coupled to the corresponding data line 2 with the source welding portion 4.

In test procedure of the liquid crystal panel, as the first, second control signal lines 9, 10 transmit switch on signals, both the sources and the drains of the two first TFT switches 7 are conducted and both the sources and the drains of the two second TFT switches 8 are conducted. Accordingly, the gate line testing short bar 5 and the gate line 1 are connected, and the data line testing short bar 6 and the data line 2 are connected, and the gate line test signal and the data line test signal are respectively transmitted to the gate line 1 and the data line 2 to implement test to the internal circuit of the liquid crystal panel; as the first, second control signal lines 9, 10 transmit switch off signals, both the sources and the drains of the two first TFT switches 7 are not conducted and both the sources and the drains of the two second TFT switches 8 are not conducted. Accordingly, the gate line testing short bar 5 and the gate line 1 are disconnected, and the data line testing short bar 6 and the data line 2 are disconnected.

Others are similar as the first embodiment and the repeated description is omitted here.

Taking the second embodiment to be compared with the first embodiment, the probability that the leakages happen at both the two TFT switches is lower, and even the leakage happens at one of the TFT switches, the other TFT switch can still guarantee the disconnected state and enormously reduce the risks of leakage failure and the mutual interferences of the normal working signals in normal display of the liquid crystal panel.

Certainly, the TFT switches of more amounts can be set but they will occupy more wiring space and are required for cooperation with the actual design of the liquid crystal panel.

In conclusion, according to the liquid crystal panel test circuit of the present invention, at least one first TFT switch is located on the path connecting each of the gate welding portions to the gate line testing short bar, and at least one second TFT switch is located on the path connecting each of the source welding portions to the data line testing short bar, and whether the first, second TFT switches are conducted or not can be respectively controlled by switching signals transmitted from the first, second control signal lines. Accordingly, the connections or disconnections between the gate line testing short bars and the gate lines, the connections or disconnections between data line testing short bars and the data lines can be controlled so that the laser cutting for the metal pins of the gate welding portions and the source welding portions is not required after testing the panel to prevent the issues bad panel display due to the corrosion occurred to the ends of the metal pins. The production efficiency is raised and the manufacture cost is reduced while the panel quality is promoted.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A liquid crystal panel test circuit, comprising a plurality of gate welding portions and source welding portions located on the periphery of a liquid crystal panel display area, a plurality of gate line testing short bars and data line testing short bars located on the periphery of the liquid crystal panel display area, and the gate welding portions are correspondingly and electrically connected to the gate line testing short bars, and the source welding portions are correspondingly and electrically connected to the data line testing short bars, and at least one first TFT switch is located on a path connecting each of the gate welding portions to the gate line testing short bar, and at least one second TFT switch is located on a path connecting each of the source welding portions to the data line testing short bar, and a gate of the first TFT switch is coupled to a first control signal line, and a gate of the second TFT switch is coupled to a second control signal line; the connections or disconnections between the gate line testing short bars and the gate lines, the connections or disconnections between data line testing short bars and the data lines are respectively controlled by switching signals transmitted from the first, second control signal lines.

2. The liquid crystal panel test circuit according to claim 1, wherein each of the gate welding portions is electrically coupled to a gate line in the liquid crystal panel display area, and each of the source welding portions is electrically coupled to a data line in the liquid crystal panel display area.

3. The liquid crystal panel test circuit according to claim 2, wherein the gate line testing short bar is coupled to a gate line test signal, and the data line testing short bar is coupled to a data line test signal; as the first, second control signal lines transmit switch on signals, both of the first, second TFT switches are conducted, and the gate line testing short bar and the gate line are connected, and the data line testing short bar and the data line are connected, and the gate line test signal and the data line test signal are respectively transmitted to the gate line and the data line; as the first, second control signal lines transmit switch off signals, both of the first, second TFT switches are not conducted, and the gate line testing short bar and the gate line are disconnected, and the data line testing short bar and the data line are disconnected.

4. The liquid crystal panel test circuit according to claim 3, wherein the switching off signal is a gate low voltage of the first TFT switch or the second TFT switch or is directly grounded.

5. The liquid crystal panel test circuit according to claim 2, wherein one first TFT switch is located on the path connecting each of the gate welding portions to the gate line testing short bar, and one second TFT switch is located on the path connecting each of the source welding portions to the data line testing short bar.

6. The liquid crystal panel test circuit according to claim 5, wherein a source of the first TFT switch is coupled to the gate line testing short bar and a drain thereof is coupled to the corresponding gate line with the gate welding portion; a source of the second TFT switch is coupled to the data line testing short bar, and a drain thereof is coupled to the corresponding data line with the source welding portion.

7. The liquid crystal panel test circuit according to claim 2, wherein two first TFT switches are located on the path connecting each of the gate welding portions to the gate line testing short bar, and two second TFT switches are located on the path connecting each of the source welding portions to the data line testing short bar.

8. The liquid crystal panel test circuit according to claim 7, wherein in the two first TFT switches on each path, a source of one first TFT switch is coupled to the gate line testing short bar, and a drain of the first TFT switch is coupled to a source of the other first TFT switch, and a drain of the other first TFT switch is coupled to the corresponding gate line with the gate welding portion; in the two second TFT switches on each path, a source of one second TFT switch is coupled to the data line testing short bar, and a drain of the second TFT switch is coupled to a source of the other second TFT switch, and a drain of the other second TFT switch is coupled to the corresponding data line with the source welding portion.

9. A liquid crystal panel test circuit, comprising a plurality of gate welding portions and source welding portions located on the periphery of a liquid crystal panel display area, a plurality of gate line testing short bars and data line testing short bars located on the periphery of the liquid crystal panel display area, and the gate welding portions are correspondingly and electrically connected to the gate line testing short bars, and the source welding portions are correspondingly and electrically connected to the data line testing short bars, and at least one first TFT switch is located on a path connecting each of the gate welding portions to the gate line testing short bar, and at least one second TFT switch is located on a path connecting each of the source welding portions to the data line testing short bar, and a gate of the first TFT switch is coupled to a first control signal line, and a gate of the second TFT switch is coupled to a second control signal line; the connections or disconnections between the gate line testing short bars and the gate lines, the connections or disconnections between data line testing short bars and the data lines are respectively controlled by switching signals transmitted from the first, second control signal lines;
wherein each of the gate welding portions is electrically coupled to a gate line in the liquid crystal panel display area, and each of the source welding portions is electrically coupled to a data line in the liquid crystal panel display area;
wherein the gate line testing short bar is coupled to a gate line test signal, and the data line testing short bar is coupled to a data line test signal; as the first, second control signal lines transmit switch on signals, both of the first, second TFT switches are conducted, and the gate line testing short bar and the gate line are connected, and the data line testing short bar and the data line are connected, and the gate line test signal and the data line test signal are respectively transmitted to the gate line and the data line; as the first, second control signal lines transmit switch off signals, both of the first, second TFT switches are not conducted, and the gate line testing short bar and the gate line are disconnected, and the data line testing short bar and the data line are disconnected;
wherein the switching off signal is a gate low voltage of the first TFT switch or the second TFT switch or is directly grounded;
wherein one first TFT switch is located on the path connecting each of the gate welding portions to the gate line testing short bar, and one second TFT switch is located on the path connecting each of the source welding portions to the data line testing short bar;
wherein a source of the first TFT switch is coupled to the gate line testing short bar and a drain thereof is coupled to the corresponding gate line with the gate welding portion; a source of the second TFT switch is coupled to the data line testing short bar, and a drain thereof is coupled to the corresponding data line with the source welding portion.
